(19) United States
(12) Patent Application Publication
(10) Pub. No.: US 2003/0012494 A1
(43) Pub. Date: Jan. 16, 2003

(54) Compact optical beam separator and method

(76) Inventors: Scott Bradshaw, Ottawa (CA); Ed Cremer, Woodlawn (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 09/901,890

(22) Filed: Jul. 11, 2001

(51) Int. Cl. G02B 6/26

(52) U.S. Cl. 385/31

(57) ABSTRACT

Apparatuses are disclosed for separating substantially parallel freespace optical beams whose origins are geometrically close. The freespace optical beams originate from a waveguide substrate. A cube shaped mirror substrate is positioned sufficiently close to the waveguide substrate to prevent the freespace optical beams from overlapping as they diverge and thereby minimizes optical cross talk. This assembly allows different freespace optical to be treated and acted upon independently. Thus, different optical components may be inserted in the separated freespace optical beams.

### FIELD OF THE INVENTION

The invention relates to the coupling of optical signals to and from optical waveguides and more specifically to the lensed coupling of optical signals from closely spaced optical waveguides into separate optical components.

### BACKGROUND OF THE INVENTION

The proliferation of the Internet and the need for increased bandwidth has lead to the deployment of vast optical communication networks. These optical networks are complex and their components are generally difficult and costly to manufacture. As the complexity of the networks increases so does the complexity of the components that are used therein. To increase the functionality of the components, optical component designers have developed components, which are integrated within silica and other waveguide substrates.

Recently, waveguide devices have been achieved some commercial success, the most common example being the arrayed waveguide grating or AWG. Waveguide devices show great promise for integration of optical devices and for miniaturization thereof. They also present tremendous manufacturing advantages analogous to those experienced by the transmission from circuit boards to integrated circuits. Despite the tremendous promise of waveguide technology, it also suffers from disadvantages. For example, coupling of light into and out of miniaturized optical devices is not a straightforward and simple task. Unfortunately, having a large number of closely spaced ports on a same end face of a waveguide substrate results in difficulty in coupling individual signals exiting or entering these ports to optical fibers or other waveguide components.

Referring to FIG. 1, a simple way of coupling light from a fiber to an integrated waveguide component is to cleave the fiber 2 and dispose a lens 3 between the fibre 2 and the waveguide component input port 4 to focus the light exiting from the fiber 2 in the port 4.

As shown in FIG. 1, unguided light 1 exiting a conventional waveguide structure begins diverging immediately. It is often convenient to insert an optical component, which is not incorporated in the waveguide structure, into the beam path. Unfortunately, once two beams exiting the waveguide component overlap it is a very complex task to place a component in the beams to act on both beams independently in a predetermined fashion. Thus it is preferred to insert any optical components into the beams of light before they overlap. A simple method of doing so, involves separating the beams spatially to ensure they do not overlap.

Referring to FIG. 2, one common approach to dealing with an array of two or more closely spaced waveguides is to bring an array of fibers into alignment with them. Advantageously, the fibres are aligned relative to each other and therefore many alignment steps are avoided. Unfortunately, each individual waveguide port needs to be mode matched to a cleaved fiber in order to achieve good coupling therebewtween. Commonly, the mode of the fibre is larger than the mode of light propagating at the port. If the mode is not matched between the waveguide port and the fibre, a tapered fiber can sometimes be used to enhance mode matching—though it prevents cleaving at an angle—resulting in a more difficult step of alignment, since much higher accuracy is needed for each of the fibres. One way of avoiding the need for tapered fibre is to re-design the waveguide with a mode expander so that a cleaved fiber is supported. This is very difficult and increases the cost of the integrated waveguide component significantly. Unfortunately, in any of the above embodiments, the use of additional bulk optical components within the optical path between the fibre and the integrated optical component is precluded because of the direct fibre/waveguide port coupling.

Additionally, the attachment of the fibres to the chip is complicated. In U.S. Pat. No. 6,212,320, issued Apr. 3, 2001, Rickman et al. describe a process of aligning the fiber to the chip. The process involves adding features to the chip specifically for this purpose.

From a packaging point of view, it is preferable to have a small package to ensure that minimum board space is used when the finished device is mounted to the board. Additionally, having all of the fibres exit from one surface in substantially the same direction is also beneficial for fibre routing on the board. Since optical fibre has a minimum bending radius, keeping all of the fibre ports on one side of the package allows easy mounting in a corner of the board, for example. Similarly, the fiber is often coiled when it comes out of the package, the coil then being fastened to the board. If the fiber exits from numerous sides then each will require a separate coil. This may seem trivial however it rapidly becomes complex as the number of optical components on a single board increases.

Referring to FIG. 3 when the array of waveguides 22 comprises a small number of waveguides for example four or less, it is possible to use a single bulk optic lens 23 in combination with a Selfoc lens 24 to guide light between the array of waveguides 22 and fibers 25. An advantage of this configuration is that the fibers are aligned to the Selfoc lens in a single alignment step, when a fibre array is used, instead of requiring four separate steps of alignment. There is more complexity than a direct fiber array coupling as described above with reference to FIG. 2 because another lens alignment is necessary, and two additional components are used—the bulk lens and the Selfoc lens. One advantage that this configuration achieves is that the waveguide ports 22a need not be mode matched to their respective fibre, so no costly mode expanders are needed. Another advantage is that there is access within the package to collimated beams, so that elements such as isolators, filters and power taps can be incorporated within the optical component. Problematically, each inserted element operates on light from all of the waveguide ports, since the collimated beams overlap; this prevents the additional components from acting on the individual optical signals in isolation. Another disadvantage as is evident from FIG. 4 is that where the waveguide device 26 has an endface 26a at a significant angle—other than perpendicular to the ports—so that focal points for light exiting two adjacent waveguide ports 22a is sufficiently proximate for a single lens to adequately—relating to acceptable loss and crosstalk—couple the signals to respective fibres.

If the ports are disposed with very large spacing therebetween, on the order of 1 mm or more, then it is possible to couple individual fibres to the individual waveguide ports. Advantageously, angled endfaces are supported by individual optical fibre coupling to individual ports. That said, the shortcomings described with reference to FIG. 1 are experienced. Alternatively, bulk optic components can be inserted within the beams close to the waveguide ports because the spacing allows sufficient room for the components. Unfortunately, such a configuration wastes waveguide real estate in order to provide separation of the output beams. The increase in waveguide real estate results in increased cost and typically in a larger final package size for the waveguide assembly.

Referring to FIG. 5, for waveguide components where there are only two or three ports for providing beams to be separated, the design of the waveguide component can be modified so that each port is on a different endface. Referring to FIG. 6, the advantages of this configuration are that the waveguide device remains compact, and use of bulk optic components with each of the separate waveguide ports is easily achieved. Unfortunately, each of endfaces having a port thereon needs to be cleaved to provide good optical quality output ports. Further, current technology would suggest coating each of the endfaces to make them anti-reflective. Cleaving of optical waveguide components typically reduces yield in manufacture resulting in increased per component manufacturing costs. To cleave devices, typically, they are divided into bars of devices—one linear row or column—and then separated into individual devices from the bar. The quality of the facets on endfaces that were joined in the bar is typically poor. To get a good cleave from bar to chip during wafer processing is difficult. Also, devices are typically coated while in the bar for better cost-effectiveness of the coating chamber. If the side endfaces needed to be coated as well, a significant increase in the device cost would result.

It would be advantageous to provide a method and device for separating light entering and/or exiting to/from closely spaced ports of a waveguide component on a same endface thereof without providing direct fibre coupling to the waveguide component.

### OBJECT OF THE INVENTION

In order to overcome these and other limitations of the prior art it is an object of the invention to provide a method and device for separating light entering and/or exiting to/from closely spaced ports of a waveguide component on a same endface thereof without providing direct fibre coupling to the waveguide component.

### SUMMARY OF THE INVENTION

In accordance with the invention there is provided an apparatus for separating closely spaced optical signals comprising: an optical substrate with a first input port and a second input port in close proximity to the first input port and along a same endface of the substrate; and, a mirror substrate with substantially reflective first and second surfaces, the mirror substrate positioned for reflecting both a first optical signal off the substantially reflective first surface and for directing it to the first input port in substantial isolation from the second input port, and a second optical signal off the substantially reflective second surface and for directing it to the second input port.

In an embodiment the invention provides an optical beam separator comprising:

an optical substrate with a first input port and a second input port in close proximity to the first input port and along a same endface of the substrate; and,

an optical substrate with substantially reflective first surface and a substantially transmissive second surface positioned for reflecting a first optical signal off the substantially reflective first surface and for directing it to the first input port in substantial isolation from the second input port, and transmitting a second optical signal through the substantially transmissive second surface and directing it to the second input port.

In another embodiment the invention provides an optical beam separator comprising: an optical substrate with a first input port and a second input port in close proximity to the first input port and along a same endface of the substrate; and, a mirror substrate with a substantially reflective first surface positioned for reflecting a first optical signal off the substantially reflective first surface and for coupling it to the first input port in substantial isolation from the second input port and shaped for allowing a second optical signal to propagate unimpeded by the substrate to the second input port at an angle for coupling thereto.

In another embodiment the invention provides an optical beam separator comprising: a waveguide substrate with a first input port for receiving a first optical input signal, a second input port for receiving a second optical signal and a third input port for receiving a third optical input signal, wherein the second input port is in close proximity to both the first and third input ports and disposed therebetween along a same endface of the waveguide substrate; at least a first optical substrate having a first highly reflective surface, a second transmissive surface and a third highly reflective surface positioned to reflect a first optical signal for coupling into the first input port in substantial isolation from the second and third input ports, to transmit a second optical signal for coupling into the second input port in substantial isolation from the third input port, and to reflect a third optical signal for coupling into the third port.

### BRIEF DESCRIPTION OF THE DRAWINGS

The invention will now be described with reference to the drawings in which:

FIG. 1 is a simplified top view of a waveguide substrate with a lens and fibre;

FIG. 2 is a diagram of a waveguide substrate with multiple outputs coupled to a fibre array;

FIG. 3 is a diagram of a waveguide substrate having an array of closely spaced waveguides thereon and optically coupled to an array of fibres via a bulk lens and a graded index lens;

FIG. 4 is a diagram of an waveguide substrate having an angled endface and an array of closely spaced waveguides thereon and optically coupled to an array of fibres via a bulk lens and a graded index lens;

FIG. 5 is a diagram of a parallelogram shaped waveguide substrate with two ports on each of two opposing endfaces;

FIG. 6 is a diagram of a parallelogram shaped waveguide substrate with one port on each of four different endfaces;

FIG. 7 is a simplified top view of a configuration of the invention for separating two optical beams exiting a same endface of a waveguide substrate including a substrate having a square cross section with mirrored faces for deflecting each of the two optical beams in orthogonal directions;

FIG. 8 is a simplified top view of a configuration of the invention for separating two very closely spaced optical beams exiting a same endface of a waveguide substrate having a square cross section with mirrored faces demonstrating an interference problem between the reflected optical beams and the waveguide substrate;

FIG. 9 is a simplified top view of a configuration of the invention for separating two very closely spaced optical beams exiting a same endface of a waveguide substrate having a square cross section with mirrored faces wherein the waveguide substrate has chamfered corners to avoid interference with the reflected beams;

FIG. 10 is a simplified top view of an embodiment of the invention featuring of a waveguide substrate and a prism with a reflective coating on an angled face wherein light exiting each of two waveguide ports is directed along two different optical paths;

FIG. 11 is a simplified top view of an embodiment of the invention featuring of a waveguide substrate and a graded index lens with a reflective coating on an angled face wherein light exiting each of two waveguide ports is directed along two different optical paths;

FIG. 12 is a simplified top view of an embodiment of the invention featuring a waveguide substrate and a mirrored surface wherein light exiting each of two waveguide ports is directed along two different optical paths;

FIG. 13 is a simplified top view of an embodiment of the invention featuring a waveguide substrate and a mirror and support wherein light exiting each of two waveguide ports is directed along two different optical paths; and,

FIG. 14 is a diagram of a waveguide substrate with two prisms which both have a mirrored surface for deflecting optical beams in different directions exiting the waveguide ports

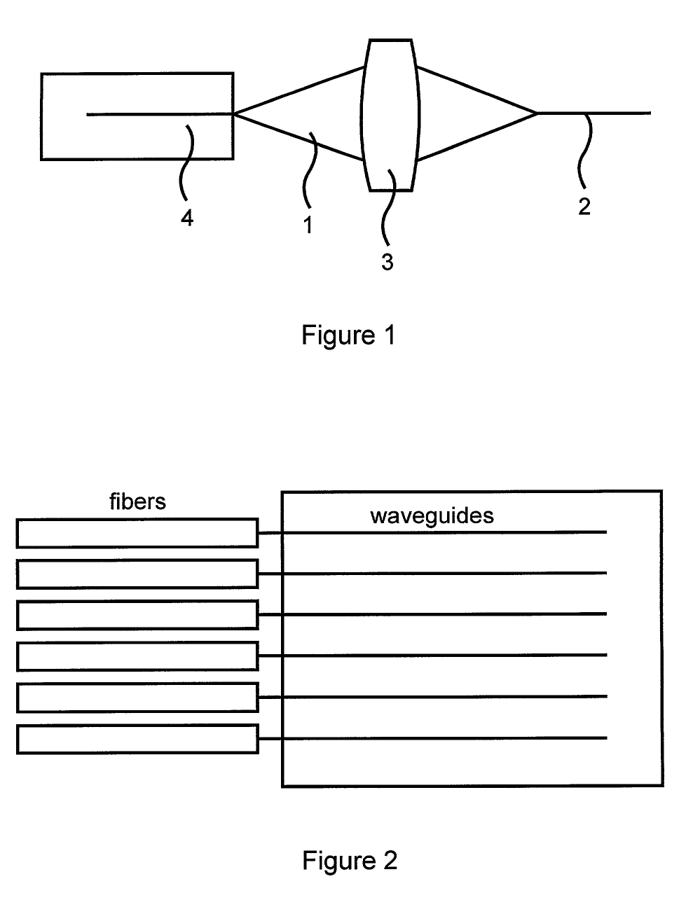

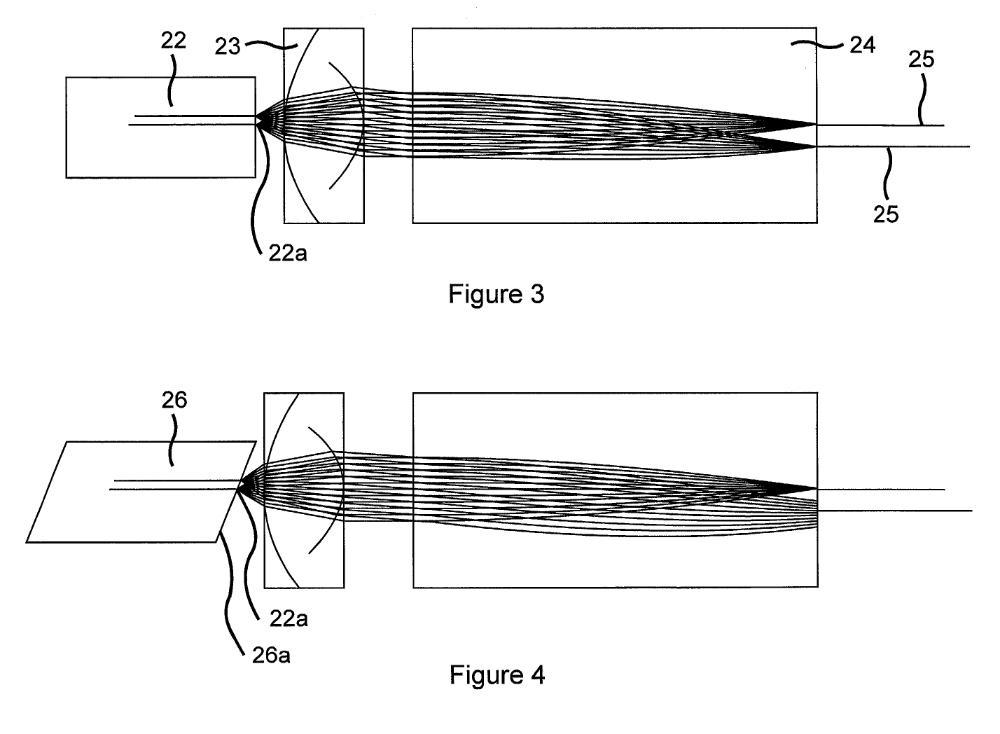

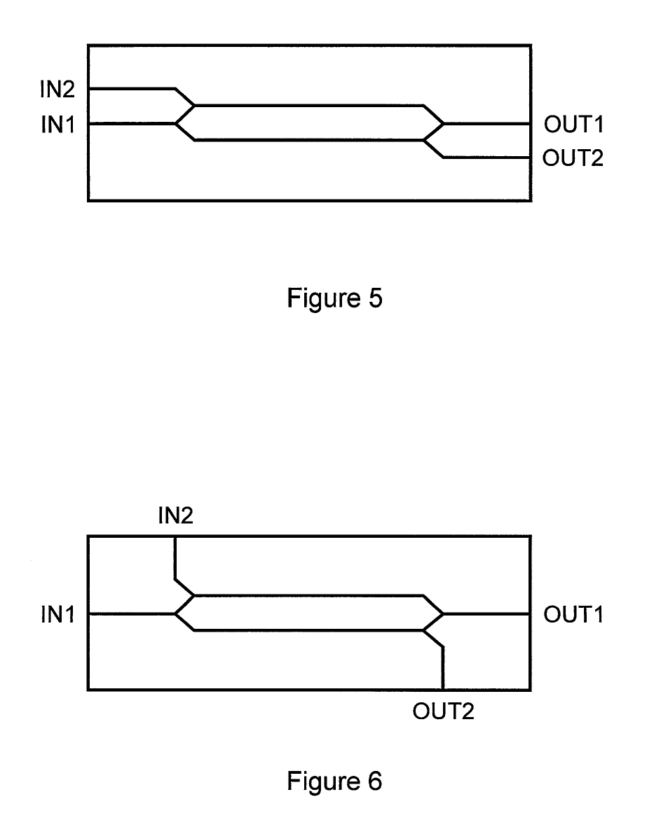

### DETAILED DESCRIPTION OF THE INVENTION

According to an embodiment, the invention is an optical component, such as a mirror, placed very closely to an endface of a waveguide substrate. Since the input/output ports of the waveguide substrate do not collimate light exiting therefrom, any light exiting the waveguide ports diverges. Therefore, as explained previously, it is advantageous that light signals leaving the substrate from different ports be spatially isolated one from another. The mirror allows two beams each exiting a separate but closely spaced output port to be spatially separated and thus acted upon independently by independent optical components as desired. This is very convenient when different components are required to act on the different optical signals.

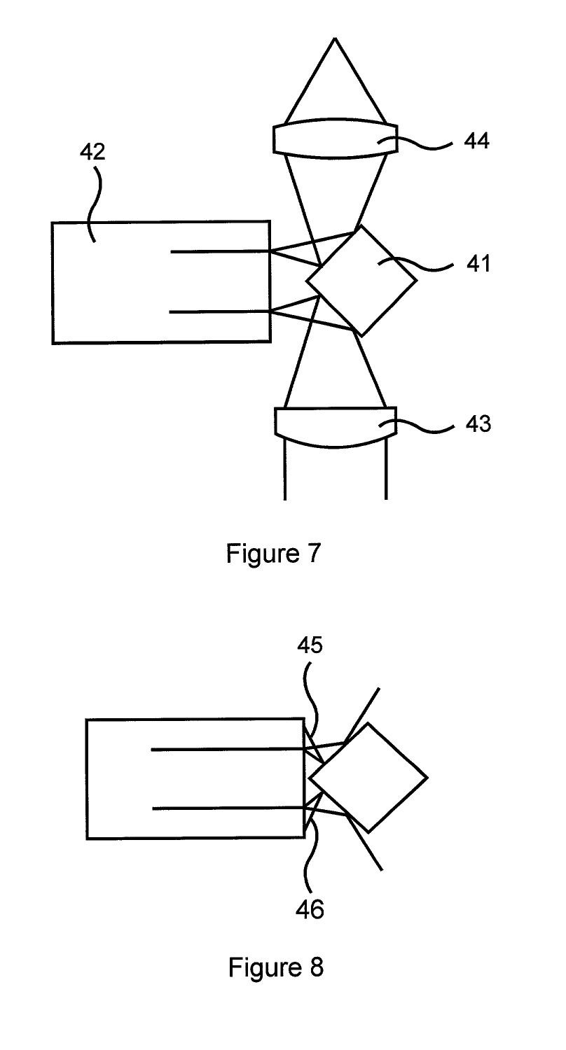

Referring to FIG. 7, in a first embodiment, a mirror in the shape of a cube is placed near the waveguide output ports. The mirror 41 is at approximately 45° to the substrate 42. The mirror is disposed such that a corner thereof is approximately central to the two waveguides for separating two light signals exiting the ports before their divergence causes them to overlap. The two light signals, now propagating in different directions are easily acted upon independently by separate optical components. In this case, the two light signals are each directed into a lens 43 and 44. The lens 43 collimates the light signal propagating therethrough whereas the lens 44 focuses the other light signal.

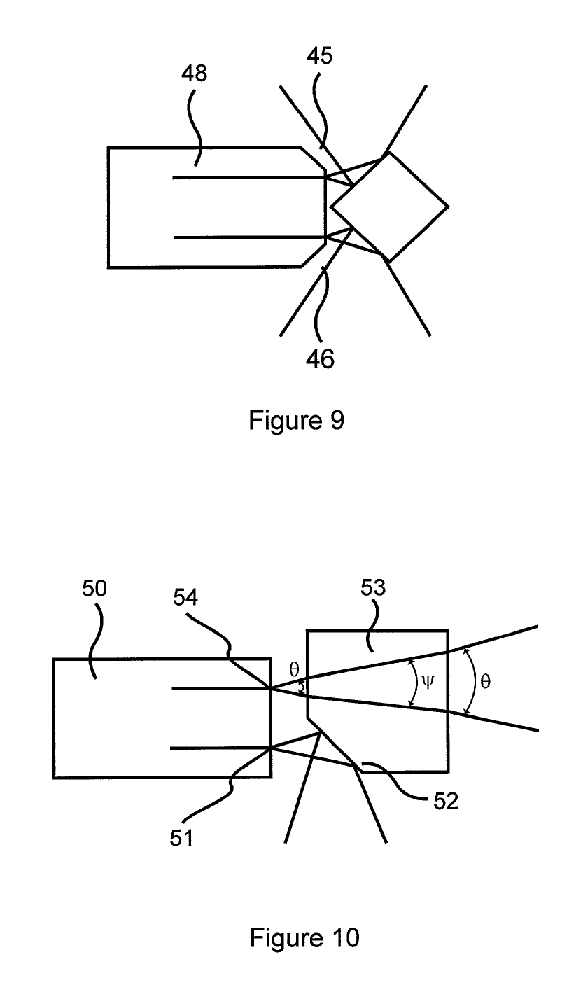

A lens used to focus a light signal should be sufficiently large to ensure that the entire light signal is channeled through the focusing region of the lens. Referring again to FIG. 7, it is clear that if there is a need to increase the optical path length between the lenses and the corresponding waveguide output port then it may be necessary to use larger lenses. While the figure illustrates the operation of the invention it does not accurately demonstrate the size and positioning of the components. Since waveguide substrates are very expensive it is preferable to make them as small as possible. With a small waveguide substrate, the waveguide output ports are closely spaced. When the waveguide output ports are much closer than those shown it is necessary to bring the mirror 41 closer to the substrate 42 to isolate the two signals. Referring to FIG. 8, if the mirror 41 is sufficiently close to the substrate 42 then the substrate itself becomes an obstacle for the light signals 45 and 46. Referring to FIG. 9, a solution to the aforementioned problem is to use a substrate 48 whose corner have been chamfered allowing the light signals 45 and 46 to propagate without interference. Typically, the chamfer would be created by a cleaving operation. Unfortunately, the cleaving of the corners of the waveguide substrate introduces other problems such as, the extra handling needed to position the waveguide substrate for cleaving, unintended damage caused by the cleaving itself, and the extra cost of the additional cleaving operations and a loss of real estate within the waveguide device.

As such, there is a delicate balance between mirror spacing from the substrate and lens size in order to ensure that most of the light exiting the output port reaches the lens and that the lens is optically close to the output port. Though in the above example, it was found that a cube having sides at right angles to each other was sufficient, when output port spacing is even closer, it is sometimes desirable to provide faces at an acute angle in order to increase the space available for positioning a lens adjacent the mirror surface. Typically, this is preferred over using a much smaller mirror substrate since smaller mirror substrates are difficult to position and affix reliably.

Referring to FIG. 10, in a second embodiment, a prism with a mirrored surface is placed in close proximity to the waveguide substrate 50. Light exiting the waveguide structure through the first port 51 diverges and reflects off the mirror surface 52. The light is reflected away from the prism 53. Light exiting the waveguide structure through the second port 54 diverges and enters the prism 53. While the beam continues to diverge as it propagates through the prism, it does not substantially overlap with the first beam—there is no overlap shown in the drawing.

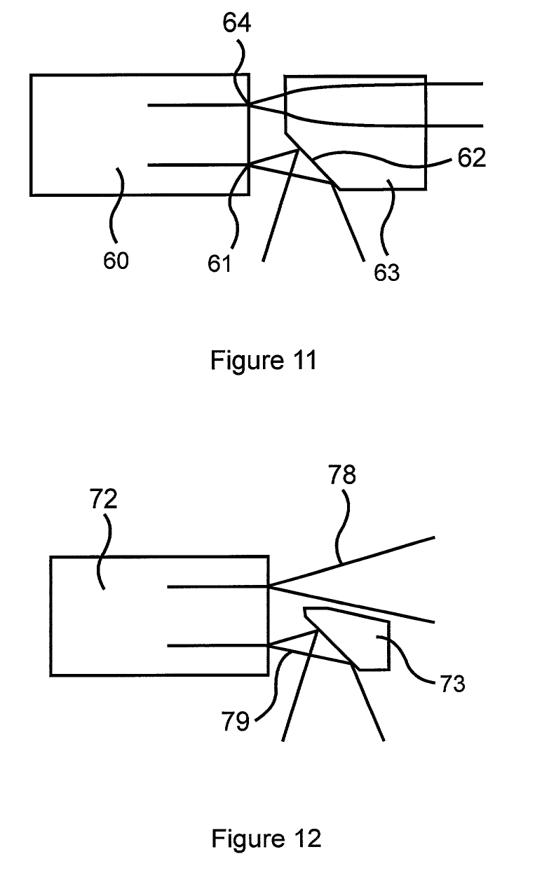

Referring to FIG. 11, an embodiment of the invention is shown. This particular configuration is analogous to the second embodiment of the invention. A prism in the form of a GRIN (graded index) lens with an angled reflective surface 62 is placed in close proximity to the waveguide substrate 60. Light exiting the waveguide structure through the first port 61 diverges and reflects off the mirror surface 62. The light is reflected away from the prism 63. Light exiting the waveguide structure through the second port 64 diverges and enters the prism 63. The prism 63 acts as a lens affecting the second light signal in a predetermined manner. As a result, the light signal exiting the substrate is, in this example, collimated by the prism 63.

Referring to FIG. 12, here only one of the two beams interact with the prism 73. A first beam 79 and a second beam 78 are shown diverging from the waveguide substrate 72. A prism 73 is carefully positioned to ensure that the first beam 79 is properly deflected while the prism 73 remains outside the optical path of the second beam 78 to allow the diverging second beam to propagate unaffected thereby.

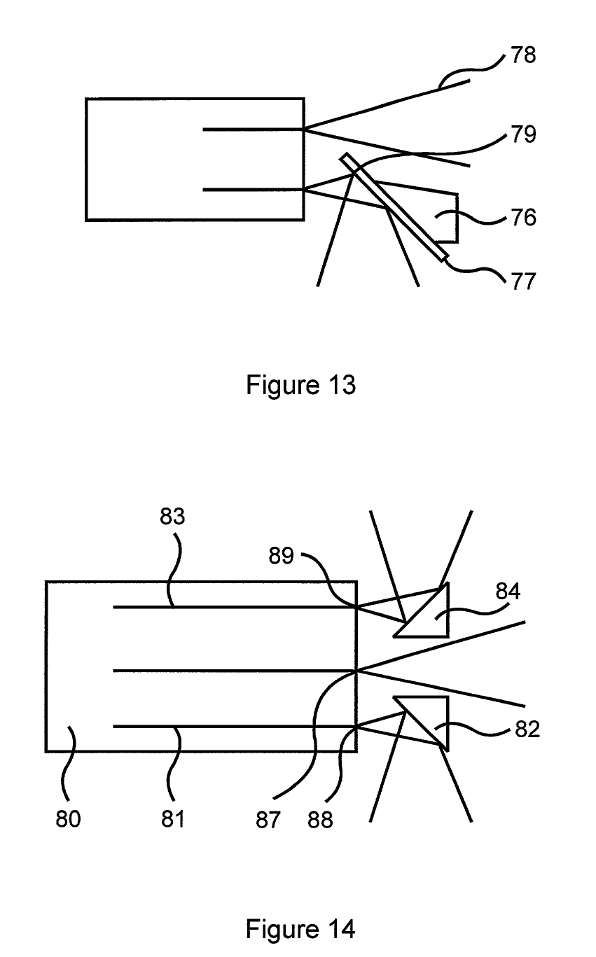

Referring to FIG. 13, a simple variation of the above embodiment is demonstrated. A first beam 79 and a second beam 78 are shown diverging from the waveguide substrate 72. A slab mirror 77 is fixed to a block 76 ensure that the first beam 79 is properly deflected while the slab mirror 77 remains outside the optical path of the second beam 78 to allow the diverging second beam to propagate unaffected thereby. This design requires that the slab mirror be very thin to ensure that it does not interfere with the second beam 78. When a small mirror must be handled, aligned and then fixed to a block it is preferable to make the mirror thick. The thick mirror is easier to handle and less subject to deformation caused by, for example, different expansion and contraction of differing materials as a result of temperature changes.

Referring to FIG. 14, in another embodiment, the waveguide substrate 80 comprises three closely spaced waveguides terminating in three closely spaced ports. A light signal exiting the first port 88 is reflected off a first prism 82. The light signal exiting the second port 89 is reflected off the second prism 84. The light signal exiting the third port 87 propagates between the prisms. Thus all three beams are separated and may be acted upon independently. Of course, it is generally a simpler manufacturing process to place the two reflective surfaces on a single optically transparent substrate such that the light signal exiting the third port 87 propagates through the material. When desired, the optically transparent material is in the form of an optical component such as a lens for affecting the propagation of the light therein.

Numerous other embodiments may be envisaged without departing from the spirit or scope of the invention.

What is claimed is:

1. An optical beam separator comprising:
an optical substrate with a first input port within a first optical path and a second input port within a second optical path, the second input port in close proximity to the first input port and along a same endface of the substrate; and,
a mirror substrate with substantially reflective first and second surfaces, the mirror substrate positioned for reflecting both a first optical signal off the substantially reflective first surface and for directing it to the first input port in substantial isolation from the second input port, and a second optical signal off the substantially reflective second surface and for directing it to the second input port.

2. An optical beam separator according to claim 1, wherein the angle between the normal to each of the two mirror surfaces is approximately a right angle.

3. An optical beam separator according to claim 1, wherein one of the first and secod surface is a curved surface.

4. An optical beam separator according to claim 1, comprising a first lens and a second lens, the first lens disposed within the first optical path and the second lens disposed within the second optical path, wherein light propagating within the first lens is isolated from light propagating within the second lens.

5. An optical beam separator according to claim 4, wherein the first lens and the second lens have an approximately same optical axis and wherein the first and second mirrored surfaces are at approximately right angles one to another such that light from the first input port is diverted in a first direction and light from the second input port is diverted along an approximately opposite direction.

6. An optical beam separator according to claim 5, wherein the light propagating in the first direction and the light propagating in the opposite direction are propagating in approximately co-linear directions.

7. An optical beam separator according to claim 1, wherein the second optical signal is substantially isolated from the first optical signal.

8. An optical beam separator comprising:
an optical substrate with a first input port and a second input port in close proximity to the first input port and along a same endface of the substrate; and,
an optical substrate with substantially reflective first surface and a substantially transmissive second surface positioned for reflecting a first optical signal off the substantially reflective first surface and for directing it to the first input port in substantial isolation from the second input port and transmitting a second optical signal through the substantially transmissive second surface and directing it to the second input port.

9. An optical beam separator according to claim 8, wherein the substantially reflective first surface is a curved surface.

10. An optical beam separator according to claim 9, wherein the substantially transmissive second surface is a surface of a lens for one of focusing and collimating light incident thereon.

11. An optical beam separator according to claim 8, wherein the substantially transmissive second surface is a surface of a lens for one of focusing and collimating light incident thereon.

12. An optical beam separator according to claim 11, wherein the lens is a graded index lens.

13. An optical beam separator according to claim 8, wherein the substrate is a lens having a first lens endface and a second other lens endface, the first lens endface formed on the substantially transmissive second surface and wherein the substantially reflective first surface is at an obtuse angle to the first lens endface and disposed on the substrate.

14. An optical beam separator comprising:
an optical substrate with a first input port and a second input port in close proximity to the first input port and along a same endface of the substrate; and,
a mirror substrate with a substantially reflective first surface positioned for reflecting a first optical signal off the substantially reflective first surface and for coupling it to the first input port in substantial isolation from the second input port and shaped for allowing a second optical signal to propagate unimpeded by the substrate to the second input port at an angle for coupling thereto.

15. An optical beam separator according to claim 14, wherein the mirror surface is a curved surface.

16. An optical beam separator according to claim 14, wherein the mirror substrate is other than a regular shape substrate and wherein the mirror surface is on a portion of the substrate extending beyond a support portion of the substrate and having a thickness sufficiently thin so as allow the second optical signal to propagate unimpeded thereby.

17. An optical beam separator comprising:
a waveguide substrate with a first input port for receiving a first optical input signal, a second input port for receiving a second optical signal and a third input port for receiving a third optical input signal, wherein the second input port is in close proximity to both the first and third input ports and disposed therebetween along a same endface of the waveguide substrate;
at least a first optical substrate having a first highly reflective surface, a second transmissive surface and a third highly reflective surface positioned to reflect a first optical signal for coupling into the first input port in substantial isolation from the second and third input ports, to transmit a second optical signal for coupling into the second input port in substantial isolation from the third input port, and to reflect a third optical signal for coupling into the third input port.

18. An optical beam separator according to claim 17, wherein one of the optical substrate surfaces is a curved surface.
